(19) United States
(12) Patent Application Publication
(10) Pub. No.: US 2026/0070644 A1
(43) Pub. Date: Mar. 12, 2026

(54) APPARATUS TO PRODUCE ELECTRIC ENERGY FOR WATER VEHICLE AND METHOD TO USE THIS APPARATUS

(71) Applicants: Jukka-Pekka TIUSANEN, Kangasala (FI); JPTUF OY, Kangasala (FI)

(72) Inventor: Jukka-Pekka TIUSANEN, Kangasala (FI)

(73) Assignee: JPTUF OY, Kangasala (FI)

(21) Appl. No.: 19/108,539

(22) PCT Filed: Sep. 7, 2023
(86) PCT No.: PCT/FI2023/050512

§ 371 Date: Mar. 4, 2025

(30) Foreign Application Priority Data
Sep. 8, 2022 (FI) 20225782

(51) Int. Cl. B63J 3/04; F03B 17/06

(52) U.S. Cl. CPC B63J 3/04; F03B 17/061; B63J 2003/046; F05B 2220/50; F05B 2260/63

(57) ABSTRACT

An apparatus fixed to a water vehicle to produce electric energy has a turbine rotor supported under the water surface in a horizontal operation position and to it fixed first axis to transfer the rotation motion from the rotor and in which apparatus the rotor has been supported and adapted into with it same centered cylinder that has been fixed to the frame with vertically to it fixed joint that is situated a vertical distance (a) from the rotor and adapted to turn in relation to the frame that has been fixed to the water vehicle round the joint axis and to settle into the direction of the water flow by its power and where the first part of the second axis has been adapted same centered with the joint axis and the first and the second axis have been connected to each other with a rotation movement direction changer when the horizontal rotation of the first axis has been adapted to change into a vertical rotation movement in the first part and the second axis has been connected to a generator to transfer the rotation movement into it and the generator has been connected to a battery to store the generated electric energy to it.

The object of this invention is an apparatus to produce electric energy for water vehicle which apparatus has been fixed to the mentioned vehicle and consists of an underwater into a horizontal operation position supported or to be supported turbine rotor and the first axis fixed to it to transfer the rotation movement from the mentioned rotor. It is also the object of the invention a method to use the mentioned apparatus.

The intention of the invention is to gather kinetic energy from the water that is flowing in relation to the water vehicle, convert it into electric energy and to store the gained energy into a battery of the water vehicle. Alternatively, the gained electric energy can also be directed directly to the electric apparatus that uses it. The mentioned electric apparatus can be in the water vehicle, on the dock, or on the shore.

Advantageous using purposes of the invention are all sail and motor boats, ships, sauna ferries and other in water moving vehicles. The apparatus according to the Invention can be used always when the water vehicle and the water around it have different directions and velocities.

It is especially advantageous to use the invention for instance when tacking with a sailboat, when driving a sailboat or a motorboat into a different direction than the water flow direction and when the boat, ship, sauna ferry or other water vehicle is in anchor in a place where the water flows. It is advantageous to use the invention also in all other situations where a water vehicle is used.

The British patent publication GB 2372783A presents one known solution to use a water turbine located in a boat to produce electric energy. A special characteristic of the apparatus is that it can be changed from to be water driven to to be air driven and vice versa, always what is best for the purpose. This happens by turning the shaft 5 vertically from water driven position into air driven position and vice versa. The fixing organ 16 of the shaft 5 binds the shaft and the water turbine 14 essentially in the direction of the bows line of the boat.

The greatest disadvantages of this known technology are same as generally in the water turbines attached to the water vehicles, that is to say the bows line KL of the boat (FIGS. 6a and 6b) defines the position of the rotor of the turbine in relation to water flow towards the water vehicle or then it must be regulated manually. When for Instance the bows line of a boat in anchor is the same as the mentioned flow the water comes occasionally to the rotor in the direction of its axis (abeam of the rotor), but when the bows line of the boat is different than mentioned flow direction the flow comes at an angle to the rotor. The disadvantage is greatest with the wooden boat when tacking and with the sailboats and the motorboats when they are in anchor in flowing water in such a way the bows line is different than the flow direction of the water.

The usage of the apparatus according to the before mentioned publication becomes disadvantageous also in such a case where the boat is driven into a direction that is different than the flow direction of the water because the boat's land velocity speed vector and the water flow velocity vector caused speed sum vector that would give the highest possible flow velocity against the rotor but as the rotor axis is in a certain angle in relation to that we have to be satisfied with the flow velocity that is smaller than the sum vector the direction of which is the same as the bows line KL of the magnitude of the component Kv1, Kv2 (FIGS. 6a and 6b) against the rotor.

The intention of this Invention is to achieve such an apparatus to produce electric energy for a water vehicle and a method to use it that disadvantages in the known technology are avoided. It is characteristic for the solution according to the invention what has been stated in the characterizing part of the claims 1 and 10.

The greatest advantage of the invention in relation to the known technology can be seen to be that the water flowing in relation to the water vehicle the velocity of which is formed by the sum of the vectors of the land velocity of the vehicle and the water flow velocity (in relation to the land) can be directed in all the driving and anchor situations to the rotor of the water turbine that is fixed to the water vehicle in a flow that is an abeam flow, that is, the most efficient possible. The apparatus according to the invention takes its most advantageous usage position automatically in all usage situations.

In this document, the term “horizontal” means essentially horizontal so that for instance the swinging or tilting water vehicle differing from the horizontal position but horizontal or almost horizontal position to operate intended apparatus is seen to be horizontal. The same principle is used to define vertical. Land velocity means the velocity of the water vehicle in relation to the land and the water flow velocity means also its speed in relation to the land.

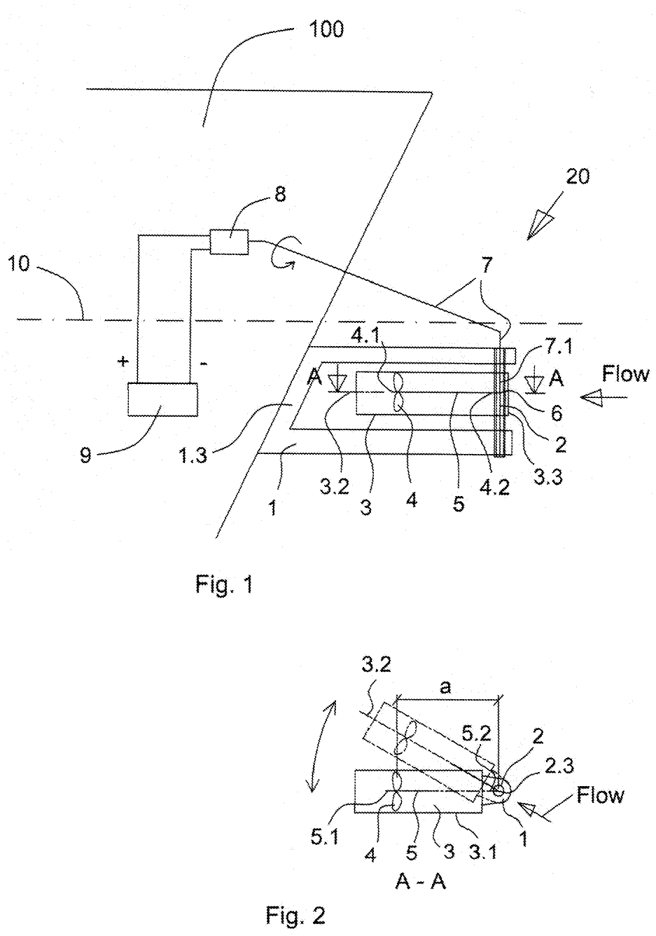

FIG. 1 shows one apparatus according to the invention installed to a boat directly from side,

FIG. 2 shows a cut of the position A-A of FIG. 1,

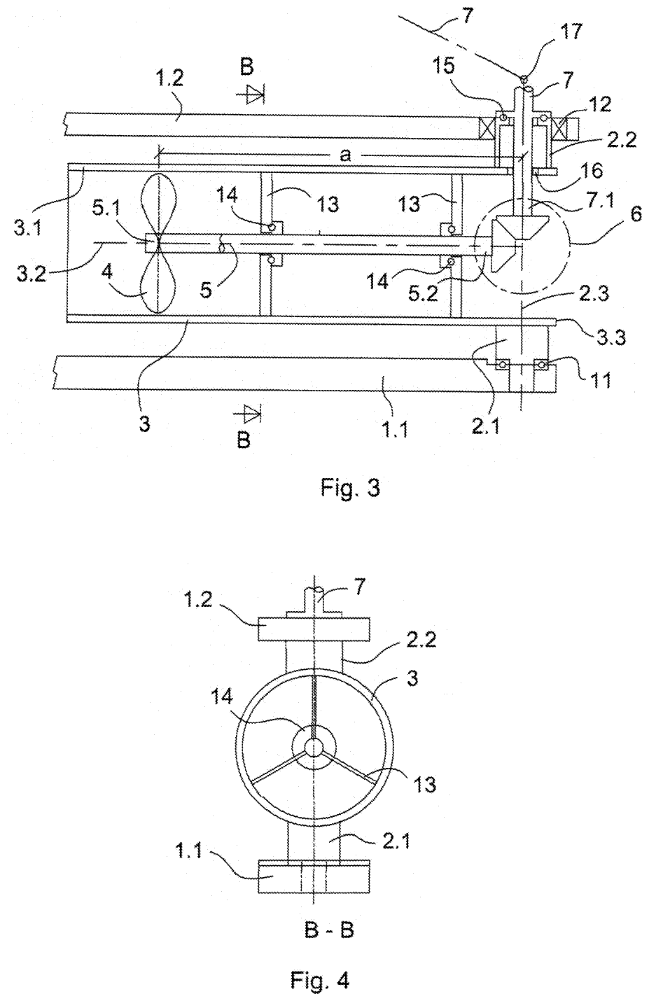

FIG. 3 shows in more detail the apparatus according to the invention of FIG. 1,

FIG. 4 shows a cut of the position B-B of FIG. 3,

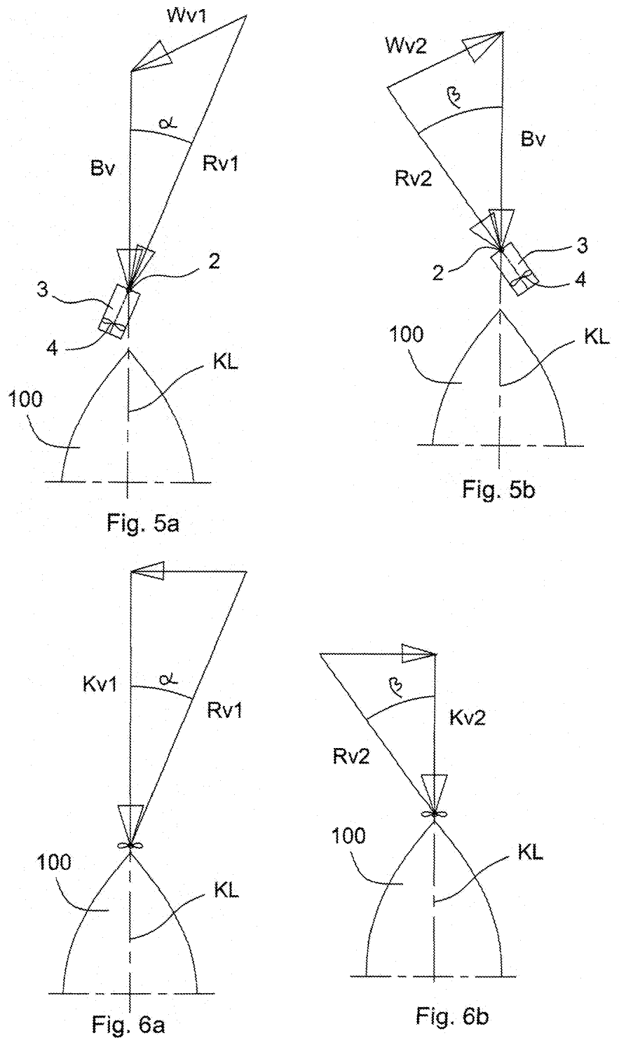

FIGS. 5a and 5b show two different usage situations of the invention,

FIGS. 6a and 6b show the achievements with the known technology in the conditions of the previous figures,

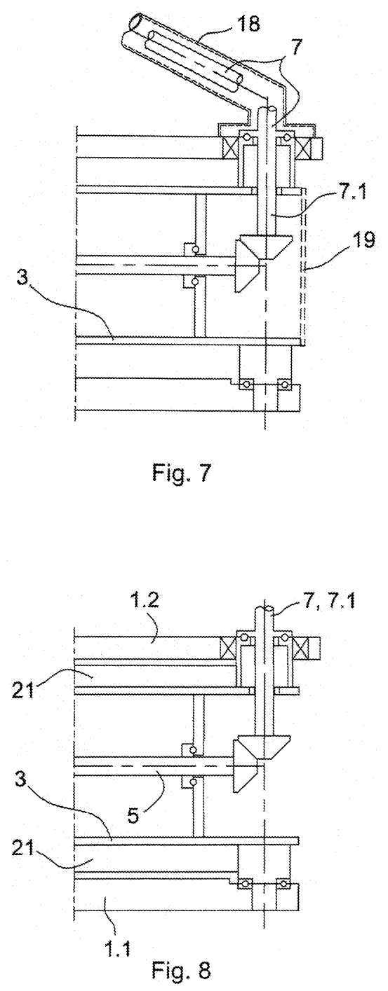

FIG. 7 shows another application of the invention,

FIG. 8 shows a third application of the invention.

Next, a construction of one favorable operation of the Invention is described by referring into the previous figures.

In FIG. 1 it has been described a setting directly from side where the apparatus 20 according to the invention has been mounted to a water vehicle 100, in this case to bows of a boat. In FIG. 2 the apparatus 20 has been shown cut in the position A-A. The apparatus 20 consists of a permanently to the boat mounted frame 1, with a vertical joint 2 to the frame horizontally underwater 10 mounted cylinder 3 and inside the cylinder same centered rotor 4 and to it fixedly from its first end 5.1 installed first axis 5. The rotor 4 has been installed to rotate in relation to the center axis 4.1 that is situated in the center axis 3.2 of the cylinder by the water pressure directed against it.

FIG. 2 illustrates the cooperation of the pieces of the apparatus 20. The cylinder 3 has been set to turn in relation to the frame 1 round the joint axis 2.3 essentially horizontally and to get the direction of the water flow in relation of the water vehicle 100. The “flow” that has been presented in FIG. 2 is thus the sum of the vectors of the land velocity of the water vehicle 100 and the water flow velocity vector, The pressure of the water flowing to the wall of the cylinder 3.1 causes that the cylinder 3 is positioned to the direction of the flow, in which case the cylinder 3 strives to find a balance state, something it reaches when the cylinder center axis 3.2 has the direction of the flow. As the cylinder 3 has been mounted essentially only to one side of the joint axis 2.3 the cylinder 3 gets its position behind the joint when seen the direction of the advance of the flow (in this example the side of the boat) and also the rotor 4 in the same side distance of a from the joint axis 2.3. The water flowing through the cylinder (flow) hits the rotor 4 and makes it rotate and this rotation movement is transferred via the first axis 5 to the position of the joint 2. The first axis 5 has been connected from its second end 5.2 to the first part 7.1 of the second axis 7 via an axial direction changer 6 which mentioned axis transfers the rotation movement to the generator 8. The electricity that the generator 8 produces is stored into a battery 9 that is situated in the water vehicle or alternatively it is used right away in electric equipment in the water vehicle, on the dock, or ashore.

In FIGS. 3 and 4 the apparatus 20 according to the invention has been described in more detail. In this example, the cylinder 3 has been situated between down part 1.1 and top part 1.2 of the frame and connected and supported with the down part 2.1 of the joint and the bearing 11 to the down part 1.1 of the frame and with the top part 2.2 of the joint and with the bearing 12 to the top part 1.2 of the frame so that the center axis of the joint, that is joint axis 2.3, goes all the way through the construction vertically. The bearing 11 is in this example a thrust bearing to support the parts of the joint and the cylinder 3 vertically to the frame 1 and the bearing 12 a radial-thrust bearing to support the parts of the joint into a vertical position and thus to support the cylinder 3 into a horizontal position. So the first axis 5 has been centered to be same centered with the cylinder 3 and supported with the supports 13 and the bearings 14 to the cylinder 3 and connected via the rotation direction changer 6 to another axis 7 first part 7.1 that is same centered with the joint axis 2.3 which axis 7 has been supported and connected with a thrust bearing 15 to the top part 2.2 of the joint to maintain its vertical position and with the bearing 16 likewise to the top part 2.1 of the joint or to the cylinder 3. In this example, the second axis 7 consists at least of one universal joint 17 to change its axial direction because of the favorable direction from the point of view of the generator. The first axis 5 has been positioned in the cylinder 3 so that its movement into the axial direction is hindered. In this example, the rotation direction changer 6 has then been adapted to change the rotation direction 90°. We will come back to the details of the rotation direction changer 6 later.

FIG. 5a shows schematically one example of the application of the invention. The flow against the bows of a vehicle 100 caused by the land velocity of a water vehicle Bv and the flow velocity of the water Wv1 that is diagonally against in the direction the vehicle goes have different directions and form together the flow velocity sum vector Rv1 that is the angle a amount different than the flow Bv and a certain amount more than it. The cylinder 3 turns in the joint 2 into the direction of the sum vector Rv1 in order to reach a balance situation and thus the flow against the rotor 4 directly is of its velocity the velocity of the sum vector Rv1.

FIG. 5b shows another application of the invention. The water vehicle 100 has the same land velocity Bv as in the previous example, the water flow Wv2 is diagonally favorable in relation to the advance direction of the vehicle and the sum vector Rv2 of the flow velocity is smaller than the land velocity Bv in this example and in an angle β with it. The cylinder 3 turns in the join 2 and now to the direction of the flow velocity sum vector Rv2 in order to achieve the balance situation and the right-angled flow with the rotor 4, the velocity is thus the sum vector Rv2.

FIGS. 6a and 6b show the operation of an apparatus according to the known technology in the before mentioned example situations. The water vehicle 100 of the FIG. 6a advances in the conditions of the FIG. 5a and right-angled against the turbine rotor coming flow is the flow velocity sum vector Rv1 component Kv1 (Kv1=Rv1 multiplied by cos(α). The water vehicle 100 of the FIG. 6b advances in the conditions of the FIG. 5b and right-angled against its turbine rotor coming flow is the flow velocity sum vector Rv2 component Kv2 (Kv2=Rv2 multiplied by cos (β)). In other words, Kv1 is smaller than Rv1 and Kv2 is smaller than Rv2 and the solution according to the known technology is thus less effective than the solution according to the invention. The differences in the efficiency depend on how big the angles α and β are.

In the solution according to the invention, the cylinder 3, the rotor 4, and the first axis 5 can turn the full 360° in the flows so that the greatest possible benefit can be achieved in all the conditions when using the water vehicle. When tacking with a sailboat or when driving in side wind the cylinder 3 finds its in each direction automatically its position to the flow velocity sum vector direction below the flow in relation to the joint 2 and when the water vehicle 100 is in anchor in a flow the cylinder 3 settles to the direction of the water flow below the flow in relation to the joint 2.

The invention realization mode in the FIG. 7 shows a casing 18 mounted around the second axis 7 to protect it. The mentioned casing prevents for instance the vegetation getting stuck to the second axis 7 and winding around it. The casing 18 can be made in any known way and in the example of the FIG. 7 it has been made of a round tube. The casing 18 can be made to reach the whole length of the second axis or only a part of it. The FIG. 7 shows also a filter 19 mounted to the end 3.3 of the cylinder to prevent vegetation, fishes, and other animals penetrating into the cylinder 3. The penetration power of the filter can be adapted so that the mentioned disadvantage is avoided essentially but that the flow of the water into the cylinder is not hindered too much. In the example of the FIG. 7, the filter is a grating.

The FIG. 8 shows an apparatus 20 according to the Invention where there are flaps 21 in the cylinder 3. They have been adapted into the cylinder lengthwise in a vertical position in the down and top part of the cylinder and their purpose is to intensify the turning of the cylinder advantageously into the direction of the flow. The flaps 21 can be more than two in the cylinder or only one.

The frame 1 is of the shape of U in the before mentioned example consisting of the down and top parts 1.1, 1.2 and the part 1.3 that connects them but they can also be realized in some other way. It is central for it that the cylinder 3 that has been joined to it by the joint 2 can operate the way that has been presented earlier.

The joint 2 can be made also of one part and the cylinder 3 can be joined by it to the frame 1 in one or more spots. Al the realization ways where the joint 2 and the cylinder 3 have been fixed sufficiently firmly from the point of view of the apparatus operation realizes the invention.

The cylinder 3 can be adapted to turn around the joint axis 2.3 full 360° or a smaller angle. The length and the diameter of the cylinder can always be selected according to the situation. The cylinder 3 can be made differently than the before example also so that only a part of its wall 3.1 has the shape of a cylinder while the other parts have some other shape. As an example we can mention a construction, where the cylinder 3 rotor 4 surrounding part is cylinder and the other part of mantle is a cone or a part of corners changing from cylinder shape. Also such a cylinder 3 realizes the invention where there around the rotor is a mantle 3.1 part of the shape of a cone. To summarize we can define that the part mounted around the cylinder mantle 3.1 rotor 4 is of the shape a cylinder, a cone, or a combination of them and the shape of the other parts can be selected more freely. It is favorable to adapt a gap between rotor 4 and the mantle 3.1. The rotor can be fixed to the first axis 5 using any known way and also the supporting of the axis to the cylinder 3. The axial direction changer 6 is in the before mentioned example a bevel gear pair and the change of the direction is thus 90°. The mentioned organ can also be a worm gear or some other to the situation suitable gear so that the rotation of the first axis 5 can be transferred further in relation to it favorably into a different direction. The rotation speed of the second axis 7 can be kept the same as the first axis 5 or it can be changed. One way to realize the change of the rotation speed is to adapt to the bevel gear pair different size gearwheels. The change of the rotation speed can also be made by placing a gear in the front side of the generator 8.

In the before example the first part 7.1 of the second axis that transfers the rotation movement has been situated favorably inside the joint 2 but the apparatus 20 can be realized also in some other useful way.

The second axis 7 can be equipped with one or more universal joints 17 and lead it/them further to the generator 8 or the mentioned gear or its rotation can be transferred with some other to the setting suitable power transfer organ to the generator or a gear. As an example of this kind of organ a belt in belt rollers can be mentioned. The bearings between the parts can be done in many different known ways, ball bearing, cone bearing, slide bearing, It is essential for the bearings that the friction of the parts that move in relation to each other can be gotten as small as possible and that the moving parts of the apparatus 20 are supported sufficiently well into their operating positions.

In the examples of this document the apparatus 20 has been located to the bows of the water vehicle 100 but it can be located also in its stern or side. It is possible to locate to one water vehicle one or more apparatuses according to the invention and the frame 1 can be built to suite its location.

It should be noted that even though this description sticks to one type for the invention favorable application example this does not want to limit the usage of the invention to only this type of example but many variations are possible as defined in the claims to be in the scope of the idea of the invention.

1. Apparatus to produce electric energy for water vehicle which apparatus has been fixed to vehicle through its frame and consists of underwater essentially to a horizontal operation position supported turbine rotor and the first axis fixed to it and the second axis and a rotation movement direction changer that connects them to transfer the rotation movement from the mentioned rotor and in which apparatus:
a. the rotor and the first axis has been adapted and supported into a cylinder that is same centered with them,
b. the cylinder has been fixed to a frame with an essentially vertical operational operation position adapted joint that is in an horizontal distance (a) from the rotor and which mentioned cylinder has been adapted to turn in relation to the frame round the joint axis and to settle into the direction of the water flow (Wv1, Wv2), flow (Bv) caused by the water vehicle land velocity against the mentioned vehicle or the sum vector (Rv1, Rv2) of the mentioned flow velocities by the power of the mentioned flow/s,
c. the horizontal rotation movement of the first axis has been adapted to change into vertical rotation movement in the first part of the second axis,
d. The second axis has been connected either directly or with some other power change organ and/or a gear to the generator to transfer the rotation movement to it,
e. the generator has been adapted to be connected to a battery to store the electric energy it produces,
wherein the first part of the second axis and to the rotation direction changer belonging organ has been adapted in a space that is in the center of the joint same centered with the joint axis and the first axis and the organ fixed to it and belonging to the rotation direction changer has been adapted to turn into the radial direction in relation to the mentioned first part of the second axis around it essentially horizontally in which case the direction of the first axis and to that fixed mentioned organ in relation to the water vehicle and the apparatus has been adapted to change directed by the cylinder.

2. The apparatus according to the claim 1, wherein the cylinder has been adapted to turn around the joint axis in relation to the frame full 360°.

3. The apparatus according to the claim 1, wherein the direction changer of the rotation movement is a bevel gear pair, worm gear, or at least one universal joint.

4. The apparatus according to claim 1, wherein the second axis consists at least one universal joint.

5. The apparatus according to claim 1, wherein it consists around the second axis adapted and at least a part of its length reaching casing to protect the mentioned axis against the harmful effect of the vegetation.

6. The apparatus according to claim 1 wherein a filter has been adapted to the end of the cylinder to protect the rotor against the harm of vegetation, fishes, and living organisms.

7. The apparatus according to claim 1, wherein there has been fixed at least one flap lengthwise in the cylinder to increase the effectiveness of the cylinder settling to the direction of the flow.

8. The apparatus according to claim 1, wherein the part around the rotor cylinder mantle has the shape of a cylinder, a cone, or a combination of them and that there is adapted a gap between the rotor and the mantle.

9. The method to use the apparatus defined in claim 1 in such a way that
a. the turbine rotor is adapted underwater under the surface in a horizontal operating position and it and to it connected first axis are supported essentially around them and to same centered with them adapted cylinder,
b. the cylinder is connected with a vertical operation position adapted joint to the frame that is fixed to the water vehicle
c. the rotor is adapted a certain horizontal distance (a) from the joint,
d. as the water flows in relation to the water vehicle and hits the rotor wall or the mentioned wall and the flap/s the cylinder settles in a balance position and then it and the rotor turn behind the joint in the direction of the flow and the center axis of the cylinder settles in the direction of the flow,
e. the mentioned flow in relation to the water vehicle that is the velocity of the sum vector (Rv1, Rv2) caused by water flow (Wv1, Wv2) and the land velocity counter flow (Bv) comes in all the operation situations of the apparatus to the rotor right-angled with it,
wherein at least a part of the first part of the second axis and to the rotation movement direction changer belonging organ that has been connected to it is located in the center place of the joint same centered with the joint axis and the first axis and to it connected to the direction changer belonging organ are adapted to turn into radial direction in relation to the mentioned second axis first part around it essentially horizontally in which case the direction of the mentioned first axis and the organ fixed to it is adapted to change in relation to the water vehicle and the apparatus directed by the cylinder.
